(19) United States
(12) Patent Application Publication
(10) Pub. No.: US 2016/0286205 A1
(43) Pub. Date: Sep. 29, 2016

(54) Three dimensional visual/pattern collection and viewing system

(71) Applicant: Michael John Breslin, St. Louis, MO (US)

(72) Inventor: Michael John Breslin, St. Louis, MO (US)

(21) Appl. No.: 15/040,893

(22) Filed: Feb. 10, 2016

Related U.S. Application Data
(60) Provisional application No. 62/176,134, filed on Feb. 11, 2015.

(51) Int. Cl. H04N 13/04

(52) U.S. Cl. CPC H04N 13/0404

(57) ABSTRACT

The three dimensional visual/pattern collection and viewing system creates a three dimensional viewing experience for multiple viewers, without the use of assistive devices, such as goggles, or other filtering and/or visual delivery systems, by incorporating a pixel design which targets the line of sight, to selectively deliver the same image a viewer would see from the same angle and distance from the subject matter in reality, or if the subject matter existed in reality, in relation to the spatial orientation of the viewer.

### CROSS REFERENCE TO RELATED APPLICATIONS

This application claims the benefit of U.S. Provisional Patent Application No. 62/176,134, filed Feb. 11, 2015, the entire disclosure of which is herein incorporated by reference.

### BACKGROUND OF THE INVENTION

1. Field of the Invention

This disclosure generally relates to data information gathering and display, such as, but not limited to video production.

2. Description of the Related Art

Since the introduction of three dimensional displays nearly a hundred years ago, there have been limitations to its acceptance for a number of collateral effects. Viewers have complained of the physical discomforts of wearing auxiliary glasses, which are used to filter the incoming visual data providing a stereoscopic, or three dimensional effect. Viewers of these types of systems have reported getting headaches, due to the unnatural delivery of visual information. Additionally, the costs associated with three dimensional viewing have slowed its acceptance.

Virtual reality methods have delivered remarkable three dimensional experiences. However, these effects must still be achieved by optical tracking and use of a helmet or goggles, to deliver the signal to an individual user.

The current methods of three dimensional viewing are not delivered in a method that mimics reality. These methods of three-dimensional viewing are rather based on using different wavelengths and colors, or fixed singular eye-dedicated delivery systems to split output into different experiences for each eye of a viewer.

Other systems, such as lenticular screens, have also been used to delivery limited range three dimensional effects.

To correct the current limitations to delivering true three-dimensional viewing, a system needs to deliver the correct view for each angle of perspective when viewing a scene or object, without the use of wearable or otherwise auxiliary, assistive devices, and to use methods that can allow simultaneous, multiple viewing on a singular display source.

### SUMMARY

The claimed invention solves these shortcomings in the present arts, by allowing an image, video, or other type of data input to be presented in a multiple viewer setting, and to be viewed in three dimensionality, without the use of assistive devices such as but not limited to, goggles, implants, special lenses and/or filters.

The claimed invention solves these shortcomings by the use of a pixel array, with pixels of a hemispheric structure, and a masking surface, which is designed to limit a viewer's line of sight to selected areas of the inner viewing deck of the hemispheric pixel unit.

The purpose of the claimed invention is to increase the quality of signal output in video viewing systems, and other types of signal output mechanisms, by allowing simultaneous, multi-user three dimensional viewing, without the need for wearable assistive devices. The increased quality of the data/signal input provided by three dimensional viewing can prove beneficial in fields such as, but not limited to education, healthcare, and entertainment.

The Three-dimensional visual/pattern collection and viewing System delivers a true three dimensional image, with correction of angle and perceived distance from any point surrounding a subject. (any point on the x, y and z axes) onto a surface, where the image shifts to the position of the viewer in a multiplicity of variations, dependent on the angle and distance of the viewer.

For instance, an image picked up by an input source that is off-center relative to the main subject, and viewed from the same angle and distance, will show the image of the background behind the main subject in the foreground. The images picked up by a source that is centered relative to the subject, and viewed from the same angle and distance, will obscure the background images that are behind the main subject in the foreground.

The system is comprised of a light/signal capture, which can use multiple inputs (cameras, sensors etc) The system optionally could use data interpolated from the collected data to generate inter-input data, and the subsequent transmission of this data onto the specially-designed screen, thus delivering an image matching the view from an identical angle in reality, and producing a true three dimensional image.

Other types of signal-delivery systems, such as RADAR and SONAR could be used as input data. For instance, an Air Traffic Controller could use a three-dimensional display in the shape of a hemispheric bubble, where the altitude of aircraft (the z-axis in relation to current oscilloscopic and other flat display fields) is represented, as well as longitude and latitude.

Signals from differing sources could also be stitched, wedded, or otherwise combined to create reality-enhanced displays, such as infrared or MRI data combined with a display of a patient. Enhanced information delivery to the medical decision-maker could advantageously lead to improved results and outcomes for patients.

The system produces three dimensional viewing without the use of goggle displays, filtering glasses, polarized lighting, lasers or holographic techniques. However, certain applications could make use of special lighting or other modifications such as these, to modify or enhance data output.

### DESCRIPTION OF DRAWINGS

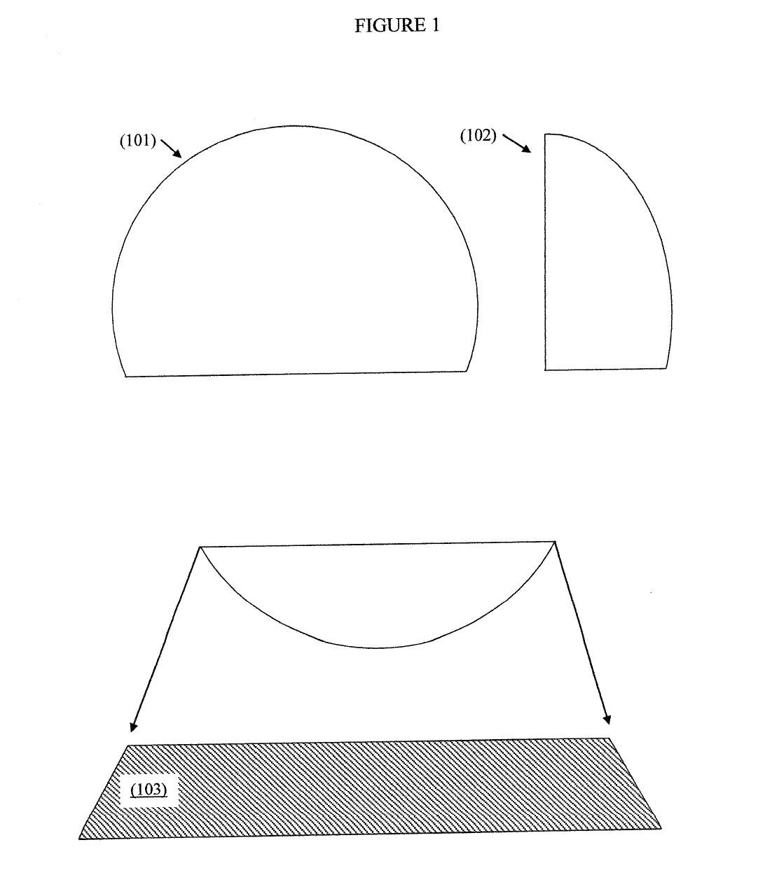

FIG. 1—Sample of viewing screen shape
(101)—Front view of sample viewing screen
(102)—Side View of sample viewing screen
(103)—Overhead view, showing viewing configuration

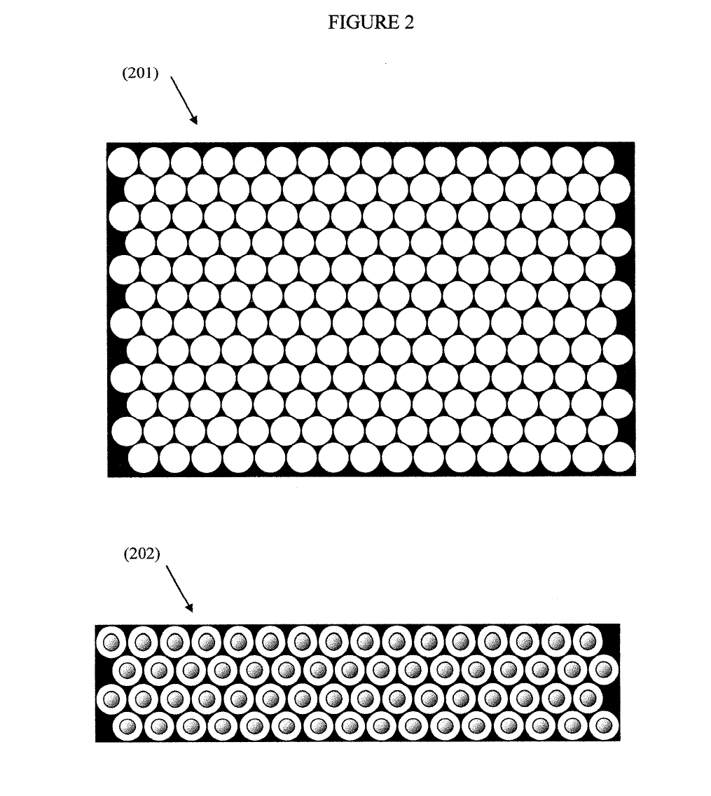

FIG. 2—Configuration of pixel unit array
(201)—General view of pixel unit array
(202)—View showing portals on pixel units in array

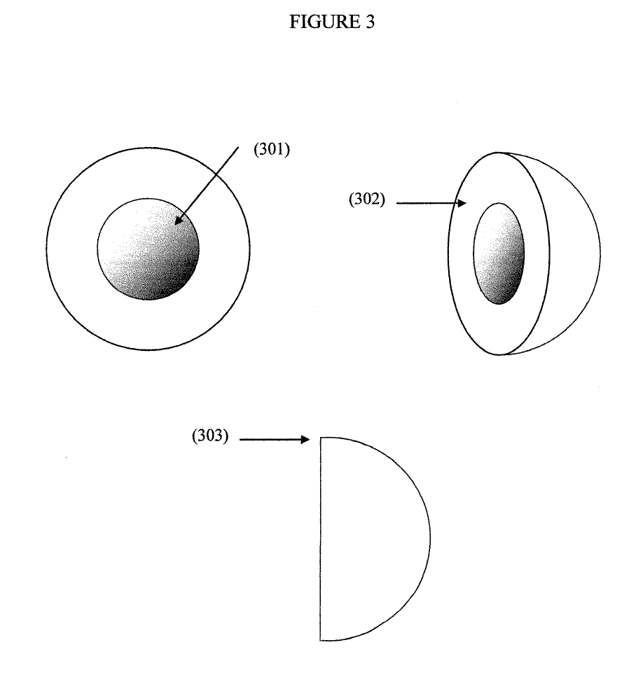

FIG. 3—Detail of pixel unit
(301)—Front view of pixel unit showing portal
(302)—Oblique view of pixel unit showing portal screen
(303)—Side view of pixel unit showing outer circumference of pixel unit

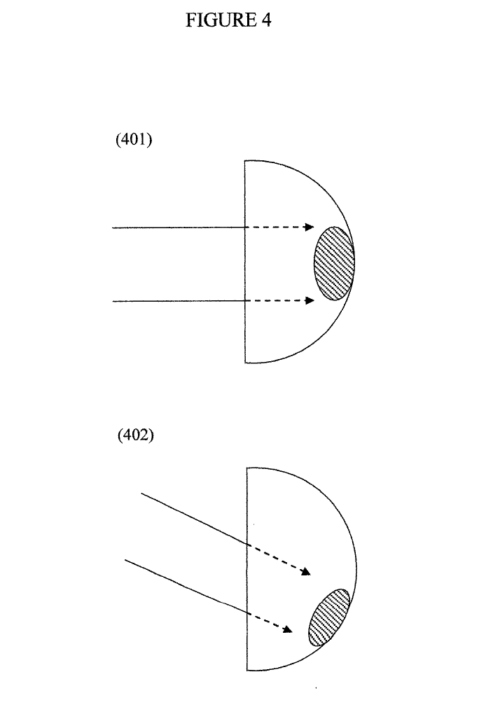

FIG. 4—Angle of viewing
(401)—Side view of pixel unit with center interior viewing area highlighted
(402)—Side view of pixel unit with off—center interior viewing area highlighted

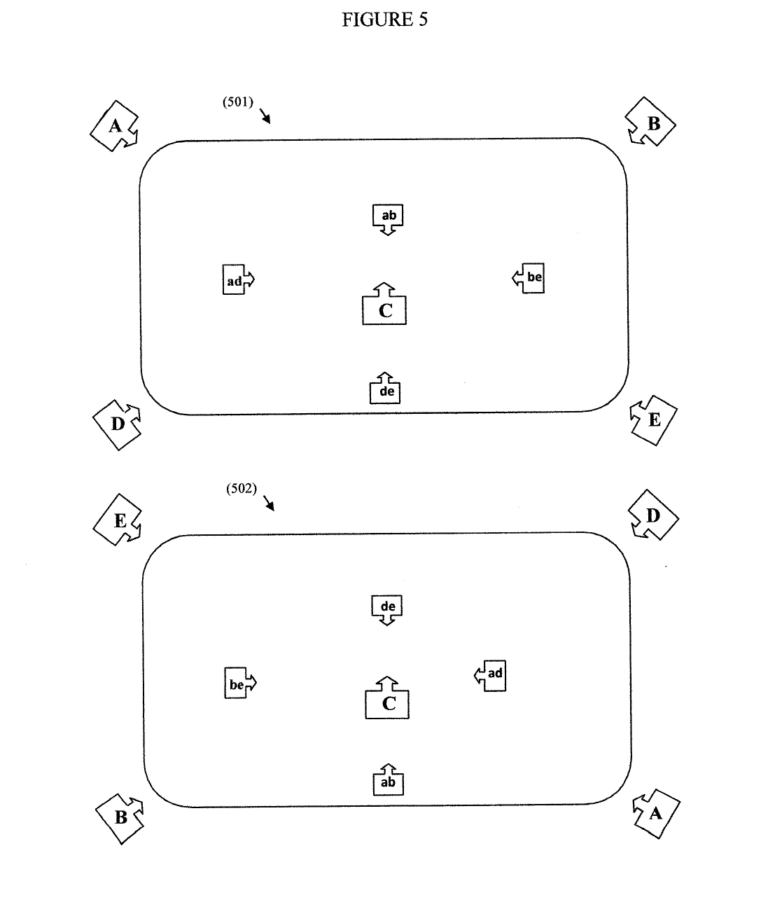

FIG. 5—Input/output collection and delivery configurations
(501)—Position of camera array in relation to subject
(502)—Position of output in relation to viewing screen

### DESCRIPTION

The Three dimensional visual/pattern collection and viewing system can employ a flat, curved, spherical and/or any hemispherical cap and/or wedge, screen configuration (101) (102), which is shaped to deliver a maximum viewing range to a specific venue, such as, but not limited to a theatrical setting. (103)

The main screen can be comprised of minute hemispheric concave screen units, in an array similar to pixels on existing CRT and LED screens. (201) On the anterior plane of these hemispheric concave pixel units, center portals (202) are situated, which are created (301) by including a portal screen, (302) which is the annulus formed by the outer circumference of the portal and the outer circumference of the pixel unit (303)

The portal screen obscures the image on the cup's surface, except for the image corresponding to the real image a viewer would experience from the same input source orientation. Viewing from directly in front of the pixel unit reveals the center surface of the pixel unit's interior viewing screen. (401) Viewing from off center of the pixel unit reveals the surface of the interior viewing screen that corresponds to the reciprocal angle of the viewer. (402)

Images are shot/collected with a multi-input (camera) system, with source orientations at the outer range of viewing on an x, y and z-axis, as well as intermediary points juxtaposed between these outer range sources and a center source. (501) The input cameras' positions fall along a plane which is identical in form to the anticipated viewing screen. An example can be a 9-array system, with a camera at center, 4 corner cameras, 2 upper and lower center cameras, and 2 left and right center cameras.

The output configuration places the output signal on the side of the screen, which is at a reciprocal angle to the angle of the viewer. The images are mirrored to correct for the switch from the front of the subject to the rear of the pixel units. (502)

The illumination of the viewing surfaces on the interior of the pixel units can be accomplished by rear light projection, LED configuration, or other methods of signal delivery technology, such as LCD.

Applications include; information delivery/entertainment in areas such as journalism, theater, sports, adventure, and drama, through delivery vehicles such as television, cinema, internet, telecomm, exhibitions; education through demonstrations, enhanced observation; medical by providing a new tool for research, clinical assessment and delivery of treatments and procedures; social support systems such as military/law enforcement strategic and tactical applications; science, technology and the arts by creating a shift in knowledge-assessment, through enhanced perspective data gathering.

1. A method for collecting and disseminating three dimensional data, comprising hemispheric-shaped pixel units, that allow for the delivery of different visual/data information, based on the angle and distance of the viewer to the viewing screen.

2. The method of claim 1, wherein a portal is formed in the anterior portion of the pixel unit, which targets the line of sight of the viewer to a particular area of the display, which is located on the interior surface of the pixel unit.

3. The method of claim 1, wherein the boundaries of the portal and the circumference of the pixel unit form an annulus, which targets viewing, by masking the viewing area within the pixel unit which is not relevant to the particular angle and distance of the viewer.

4. The method of claim 1, wherein different shapes of screens are created, based on the application of use such as, but not limited to table-mounted convex hemisphere displays for air traffic control, or size appropriate convex hemi-ellipsoid displays for viewing sporting events, such as, but not limited to football, soccer or basketball.

5. The method of claim 1, wherein other forms of data, such as, but not limited to infrared data can be represented within the three dimensional display.

6. The method of claim 1, wherein size appropriate concave displays can be used within a dome structure, to simulate exterior and interior space, based on input surveys using multiple input-gathering arrays.

7. The method of claim 1, wherein existing video content or other data source, can be modified through interpolation techniques or other methods, to work within the parameters of the method described in claim 1.

8. The method of claim 1, wherein the illumination of the light entities on the interior surface of the hemisphere can be by accomplished by, but not limited to rear light projection, LED or LCD methods.
